(19) United States
(12) Patent Application Publication
(10) Pub. No.: US 2026/0095704 A1
(43) Pub. Date: Apr. 2, 2026

(54) HIGH-PERFORMANCE, LOW-POWER ELECTROACOUSTIC TRANSDUCER

(71) Applicant: STMicroelectronics International N.V., Geneva (CH)

(72) Inventors: Fabrizio CERINI, Magenta (IT); Filippo Pietro PERLI, Milano (IT); Silvia ADORNO, Novate Milanese (IT)

(73) Assignee: STMicroelectronics International N.V., Geneva (CH)

(21) Appl. No.: 19/338,329

(22) Filed: Sep. 24, 2025

(30) Foreign Application Priority Data
Sep. 30, 2024 (IT) 102024000021603

(51) Int. Cl. H04R 17/00; H04R 7/06; H04R 7/18; H04R 31/00

(52) U.S. Cl. CPC H04R 17/00; H04R 7/06; H04R 7/18; H04R 31/003; H04R 31/006; H04R 2201/003; H04R 2400/11

(57) ABSTRACT

A microelectromechanical electroacoustic transducer includes: a supporting frame containing semiconductor material; a membrane of semiconductor material connected to the supporting frame along a perimeter; a piezoelectric transducer on a central portion of the membrane. The piezoelectric transducer is configured to cause a deflection at rest of the membrane from a planar configuration towards a first side of the membrane, in the absence of electrical stimuli to the piezoelectric actuator, and to cause an induced deflection of the membrane opposite to the deflection at rest towards a second side of the membrane in response to an electrical driving signal.

### PRIORITY CLAIM

This application claims the priority benefit of Italian Application for Patent No. 102024000021603 filed on Sep. 30, 2024, the content of which is hereby incorporated by reference in its entirety to the maximum extent allowable by law.

### TECHNICAL FIELD

This disclosure relates to a high-performance, low-power electroacoustic transducer.

### BACKGROUND

As is known, users of the vast majority of mobile and land processing and communication devices, such as smartphones, tablets, portable and desktop computers, benefit from the use of headphones and earphones, which are by now extremely widespread. This widespread use, together with the fact that in many cases headphones and earphones are worn continuously for long periods of time, brings with it the need to provide comfortable and practical devices, without sacrificing the quality of audio reproduction. There is therefore an important push towards the manufacture of miniaturized electroacoustic transducers, such as speakers and microphones. Other miniaturized electroacoustic transducers towards which there is growing interest are used for example in probes for ultrasound inspection and, in general, in ultrasound imaging (Piezoelectric Micromachined Ultrasonic Transducer, PMUT).

However, the solutions currently available are not entirely satisfactory and do not represent a valid compromise between dimensions, performance in terms of high Sound Pressure Level (SPL—for transmitters) or sensitivity (for receivers), consumption and costs.

A first type of electroacoustic transducer, in particular a speaker, utilizes traditional electromagnetic actuation and is capable of ensuring high reproduction quality. However, electromagnetic actuation speakers are not suitable for being miniaturized beyond a certain limit.

Other solutions based on MEMS (Micro-Electro-Mechanical-Systems) technology allow better miniaturization levels to be obtained, but costs and/or performance are not yet suitable enough to replace the electrodynamic speakers.

For example, hybrid devices are known wherein a microelectromechanical actuator, often of the piezoelectric type, is coupled to a polymeric membrane, which is caused to vibrate. The polymeric membrane has the advantage of high flexibility (low Young's modulus), which allows a good response, but has critical issues from the point of view of process and costs. In fact, the membrane is applied to the portion of the device that houses the actuator only in the back-end step, i.e., in dedicated processing steps, subsequent to the manufacture of the actuator itself. Furthermore, hybrid micro-speakers are not suitable for being assembled on boards by using SMT (Surface Mount Technology), because the membrane is not capable of withstanding soldering temperatures.

Other devices made entirely by using MEMS technology meet the miniaturization and cost requirements, but do not achieve sufficient performance in terms of response dynamics and bandwidth.

In particular, some micro-speakers comprise a semiconductor membrane connected to a supporting frame along its perimeter. The criticality of these devices lies mainly in the poor flexibility of the membrane. In fact, to obtain a suitable sound pressure level, the area reduction of the membrane due to miniaturization should be compensated by a greater displacement (the sound pressure is, in fact, proportional to the product A*d*f, where A is the area of the membrane, d is the displacement and f is the frequency). However, the stiffness of the semiconductor material does not allow sufficient displacement, especially at low frequencies.

In other MEMS micro-speakers, the membrane is discontinuous in the inner portion precisely to have greater flexibility and allow a wider displacement. Rather than a real membrane, the transducer comprises a plurality of cantilever structures, each of which defines a segment of a polygon or a sector of a circle and extends from a supporting frame. The vertices of the segments or sectors are adjacent to each other at the center of the transducer, without however being joined. A wider response dynamics may thus be obtained, which, however, is not constant over the audio bandwidth. A misalignment in the out-of-plane direction of the cantilever structures, again especially at low frequencies and resonance, may in fact cause fluidic passages with uncontrolled widths between adjacent sectors, introducing vents in the membrane that may compromise the performance. Furthermore, the quality of the response of MEMS micro-speakers of this type is heavily influenced by process variations, since even small differences in the cantilever structures may cause non-uniform movements and asymmetry in the sound emission, affecting the Total Harmonic Distortion (THD).

Again with the aim of increasing the maximum displacement, MEMS micro-speakers with distinct piezoelectric actuators have been proposed to move the membrane in opposite directions with respect to a rest configuration wherein no stresses are applied. In particular, a peripheral piezoelectric actuator is arranged along the perimeter of the membrane and applies forces that tend to deform the membrane in a first direction, and a central piezoelectric actuator is arranged centrally on the membrane and applies forces that tend to deform the membrane in a second direction Ie to the first direction. In known devices of this type, however, the increase in displacement is partially limited by the fact that the membrane is continuous and therefore more rigid in order to be capable of accommodating the central actuator and its electrical connections. Furthermore, the power absorbed by the piezoelectric actuators depends not only on the voltage and the actuation frequency, but also on the capacitance of the actuators themselves. The latter should be minimized to reduce the power absorbed and increase the autonomy of the devices, which are usually battery powered. On the other hand, the area of the actuators cannot be reduced beyond a certain limit, because the force applied by each actuator would decrease accordingly, limiting the maximum displacement of the membrane.

### SUMMARY

It is therefore an aim of this disclosure to provide an electroacoustic transducer that allows the limitations described to be overcome or at least mitigated.

A microelectromechanical electroacoustic transducer includes a supporting frame containing semiconductor material and a membrane of semiconductor material connected to the supporting frame along a perimeter. A piezoelectric transducer is located on a central portion of the membrane. The piezoelectric transducer is configured to cause a deflection at rest of the membrane from a planar configuration towards a first side of the membrane in the absence of electrical stimuli to the piezoelectric transducer, and to cause an induced deflection of the membrane opposite to the deflection at rest towards a second side of the membrane in response to an electrical driving signal.

The piezoelectric transducer and the membrane may form a composite membrane and have respective residual stress states of a compression type.

The piezoelectric transducer may be located on the first side of the membrane.

The membrane may be divided into sectors by radial slits extending from a periphery of the membrane up to a distance from a center of the membrane.

The piezoelectric transducer may include an annular actuator region and lobes extending in a radial direction from the annular actuator region, each on a respective sector of the membrane.

The transducer may include elastic elements defined by respective portions of the membrane, with the membrane being connected to the supporting frame by the elastic elements. Metal lines may extend on respective elastic elements on the membrane from the respective elastic elements to the piezoelectric transducer.

The metal lines may be of a metal immune to oxidation by exposure to the atmosphere, for example gold or platinum.

The metal lines may be free of coating and exposed on the membrane and on the elastic elements.

The piezoelectric transducer may include a bottom electrode, a piezoelectric body on the bottom electrode and a top electrode on the piezoelectric body. The metal lines may include a first metal line connecting the top electrode to a first pad on the supporting frame and a second metal line connecting the bottom electrode to a second pad on the supporting frame.

Each sector may include a pair of respective elastic elements arranged symmetrically to each other with respect to an axis extending along a bisector of the respective sector. Each elastic element may include an outer anchor fixed to the supporting frame, an inner anchor connected to the central portion of the membrane, outer arms extending in opposite directions from the outer anchor and inner arms extending in opposite directions from the inner anchor.

In each elastic element the outer arms and the inner arms may be parallel to each other and connected to each other, to the outer anchor and to the inner anchor so as to form a slot.

The first metal line and the second metal line may extend on respective distinct sectors of the membrane and each on both elastic elements of the respective sector.

Alternatively, the first metal line and the second metal line may extend on a same one of the sectors of the membrane and each on a respective one of the elastic elements of the sector.

The metal lines may include dummy metal lines in each sector of the membrane opposite to one of the sectors accommodating the first metal line and/or the second metal line. The metal lines may extend at least on the elastic element of the respective sector of the membrane and up to the piezoelectric transducer and may be electrically insulated from the piezoelectric transducer.

The membrane may have N-fold rotational symmetry, where N is an integer.

### BRIEF DESCRIPTION OF THE DRAWINGS

For a better understanding of the present invention, preferred embodiments are provided, by way of non-limiting example, with reference to the attached drawings, wherein:

FIG. 1 is a simplified block diagram of a processing and communication device;

FIG. 2 is a top-plan view of an electroacoustic transducer in accordance with an embodiment of the present invention incorporated into the device of FIG. 1;

FIG. 3 shows the electroacoustic transducer of FIG. 2 with parts removed for clarity;

FIG. 4 shows an enlarged detail of the electroacoustic transducer of FIG. 2;

FIG. 5a is a cross-section through the electroacoustic transducer of FIG. 2 in a first operating configuration;

FIG. 5b is a perspective view of a portion of the device of FIG. 2 in the first operating configuration;

FIG. 6a is a cross-section through the electroacoustic transducer of FIG. 2 in a second operating configuration;

FIG. 6b is a perspective view of a portion of the device of FIG. 2 in the second operating configuration;

FIG. 7 is a simplified cross-section through the electroacoustic transducer of FIG. 2, sectioned along line VII-VII of FIG. 2;

FIG. 8 is a simplified cross-section through the electroacoustic transducer of FIG. 2, sectioned along line VIII-VIII of FIG. 2;

FIG. 9 shows another enlarged detail of the electroacoustic transducer of FIG. 2;

FIG. 10 shows a further enlarged detail of the electroacoustic transducer of FIG. 2;

FIG. 11 is a top-plan view of an electroacoustic transducer in accordance with a different embodiment of the present invention usable in the device of FIG. 1;

FIG. 12a is a cross-section through the electroacoustic transducer of FIG. 11 in a first operating configuration;

FIG. 12b is a cross-section through the electroacoustic transducer of FIG. 11 in a second operating configuration.

### DETAILED DESCRIPTION

The following description refers to the arrangement shown in the drawings; consequently, expressions such as “above”, “below”, “upper”, “lower”, “top”, “bottom”, “right”, “left” and the like relate to the accompanying Figures and are not to be interpreted in a limiting manner.

For convenience, hereinafter reference will be made to electroacoustic transducers used in micro-speakers. However, this is not to be understood in a limiting sense. Electroacoustic transducers according to the invention may be used in different devices, both receivers and transmitters, including microphones and ultrasound probes, and, in general, in the field of ultrasound imaging (PMUT, Piezoelectric Micromachined Ultrasonic Transducers).

Furthermore, here and below, the term transducer is intended to generically indicate a device that converts a first physical quantity (or form of energy) into a corresponding (different) second physical quantity (or form of energy) or vice versa. In some cases, a transducer may be used bidirectionally to convert the first physical quantity into the second physical quantity or the second physical quantity into the first physical quantity, according to the operating conditions. In particular, it is understood that an electroacoustic transducer is a device that converts acoustic waves into a corresponding electrical signal or, vice versa, converts an electrical signal into corresponding acoustic waves. An electroacoustic transducer may be used bidirectionally both to convert acoustic waves into a corresponding electrical signal and to convert an electrical signal into corresponding acoustic waves (for example in ultrasound probes or in some earphones with active noise cancellation). Furthermore, it is understood that a piezoelectric transducer converts forces or pressures applied to faces of the transducer into a corresponding electrical signal and converts an electrical signal into corresponding forces or pressures applied by faces of the transducer. The piezoelectric transducers are normally usable bidirectionally.

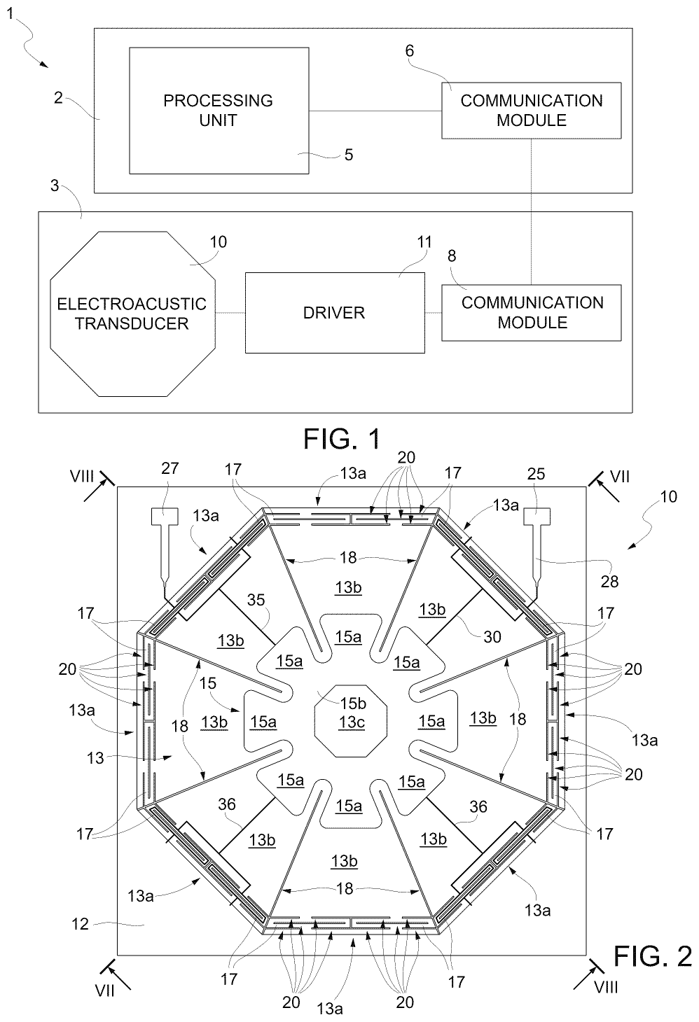

With reference to FIG. 1, an electronic system denoted as a whole with the number 1 comprises a processing and communication device 2 coupled in communication with a micro-speaker 3.

The processing and communication device 2 may be any portable or land device that supports audio communication with a reproduction peripheral, such as the micro-speaker 3. The processing and communication device 2 may be, but it is not limited to, a portable computer, a personal computer, a tablet, a smartphone or a wearable device, for example a smartwatch, and comprises, in particular, a processing unit 5 and a communication module 6, coupled with a corresponding communication module 8 of the micro-speaker 3. The processing and communication device 2 may generally comprise further components not illustrated, such as a display unit, memory units, insertion and pointing devices, peripherals, a battery, I/O interfaces.

The micro-speaker 3 comprises, in addition to the communication module 8, an electroacoustic transducer 10 and a driver 11. The driver 11 receives audio signals through the communication module 8 and actuates the electroacoustic transducer 10.

The communication modules 6, 8 of the processing and communication device 2 and of the micro-speaker 3 may be mutually coupled by a wireless or cable connection.

With reference to FIGS. 2-8, the electroacoustic transducer 10 is a piezoelectric-type membrane microelectromechanical transducer and comprises a supporting frame 12, a membrane 13, and a piezoelectric transducer, in particular a piezoelectric actuator 15.

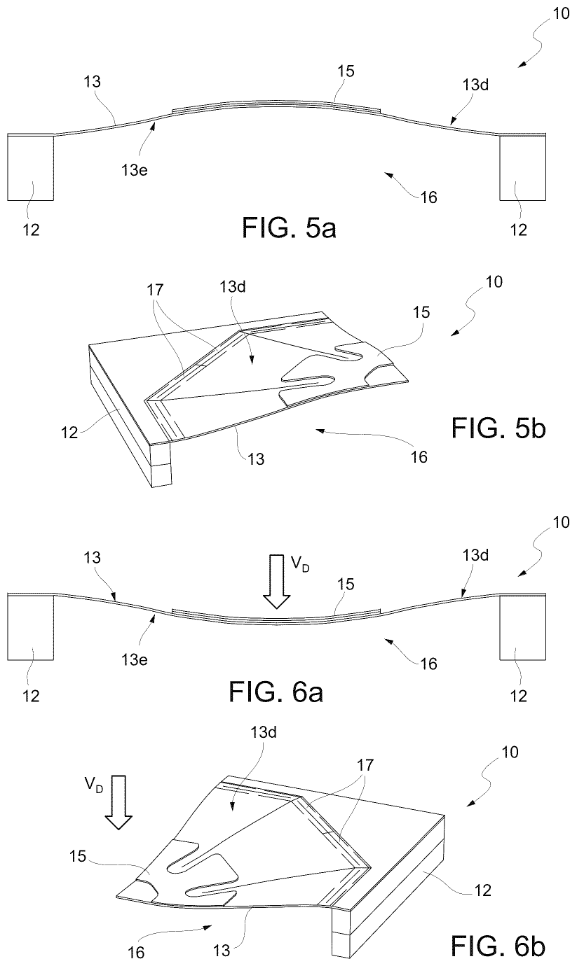

The supporting frame 12 is of semiconductor material and has a cavity 16 (FIGS. 5a, 5b, 6a, 6b, 7, 8) open on one side and closed on the opposite side by the membrane 13. More precisely, the supporting frame 12 may comprise a substrate, for example of monocrystalline silicon 12a, a dielectric layer 12b and one or more structural layers 12c which may include epitaxial layers, again of monocrystalline silicon, or layers of polycrystalline silicon grown from seed in an epitaxial reactor or deposited layers.

The membrane 13, also of semiconductor material, for example polycrystalline silicon in continuity with the outermost of the structural layers 12c of the supporting frame 12, is connected to the supporting frame 12 along its perimeter. The membrane 13 may have a thickness of, for example, between 3 μm and 25 μm. In one embodiment, the membrane 13 is polygonal and has an N-fold rotational symmetry with respect to an axis perpendicular to the membrane and passing through the center, with N being an integer. It is understood that a body is provided with an N-fold rotational symmetry with respect to an axis when the body is invariant under rotations of 360°/N around the axis. For example, the membrane 13 may have the shape of a regular octagon. Furthermore, an N-fold rotational symmetry with N even may be advantageous in terms of balancing the stresses (e.g., for the arrangement of dummy connections, as explained in detail below).

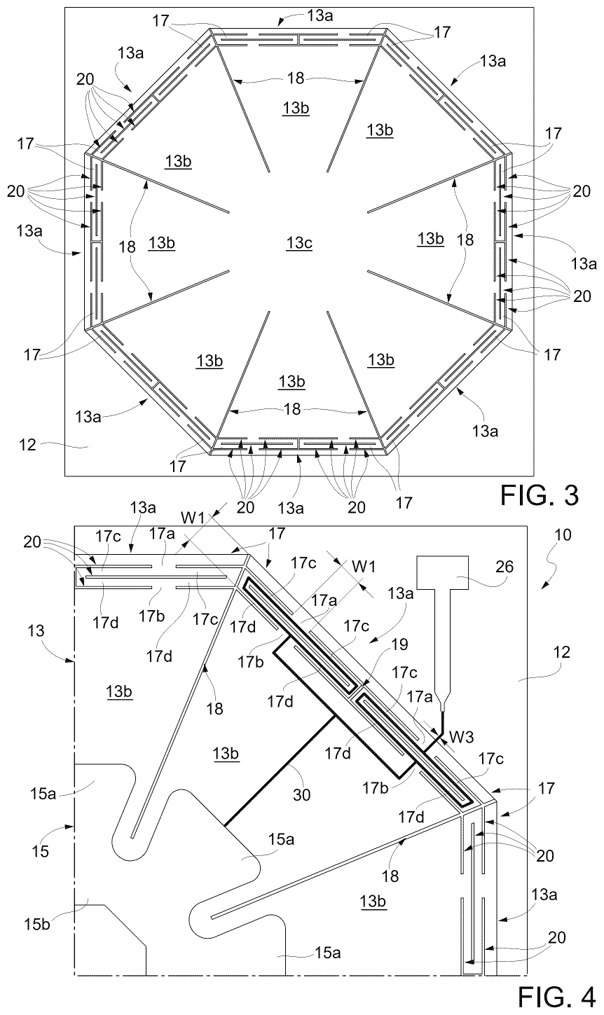

With reference, in particular, to FIG. 3, which for clarity only shows the supporting frame 12 and the membrane 13, the membrane 13 is connected to the supporting frame 12 along its perimeter by elastic elements 17. The membrane 13 is divided into a plurality of sectors 13a, delimited by radial slits 18 that extend in a radial direction from respective vertices of the membrane 13 towards the inside, up to a distance from the center of the membrane 13. In one embodiment, the radial slits 18 all have the same width. Furthermore, the width of the radial slits 18 is less than twice the thickness of a viscous boundary layer of the air, in particular in an operating temperature range of, for example, between −20° C. and +40° C. In one embodiment, the width is less than the thickness of the viscous boundary layer of the air and is in any case not greater than 10 μm, for example 5 μm. Furthermore, a ratio between the width and a thickness of the membrane 13 is not greater than 1.

In the membrane 13, the radial slits 18 define tabs 13b, one for each sector 13a. The tabs 13b are coupled to the supporting frame 12 by respective elastic elements 17 and are connected to each other by a continuous central portion 13c of the membrane 13, radially internal with respect to the radial slits 18.

In the example of FIGS. 2-8, each tab 13b is coupled to the supporting frame 12 by a pair of respective elastic elements 17, arranged symmetrically to each other with respect to an axis A that extends along a bisector of the respective sector 13a. The arrangement of the elastic elements 17 is the same in each sector 13a of the membrane 13, and for convenience hereinafter reference will be made to the elastic elements of only one of the sectors 13a, it being understood that what has been described also applies to all the others. It is also understood that the arrangement and the shape of the elastic elements might be different from those described.

With reference, in particular, to the enlargement of FIG. 4, each elastic element 17 is formed directly by a portion of the membrane 13 and comprises an outer anchor 17a, an inner anchor 17b, outer arms 17c and inner arms 17d. The outer anchor 17a and the inner anchor 17b are fixed respectively to a respective side of the supporting frame 12 delimiting the cavity 16 and to the tab 13b of the respective sector 13a of the membrane 13 along the axis A. The outer arms 17c and the inner arms 17d are parallel to each other and are connected to each other, to the outer anchor 17a and to the inner anchor 17b so as to form a slot. In more detail, the outer arms 17c extend perpendicular to the axis A in opposite directions from the outer anchor 17a up to the radial slits 18 that delimit the respective sector 13a. Similarly, the inner arms 17d extend perpendicular to the axis A in opposite directions from the inner anchor 17b up to the radial slits 18 that delimit the respective sector 13a. The outer arms 17c and the inner arms 17d are joined to each other at the respective distal ends, relative to the outer anchor 17a and the inner anchor 17b.

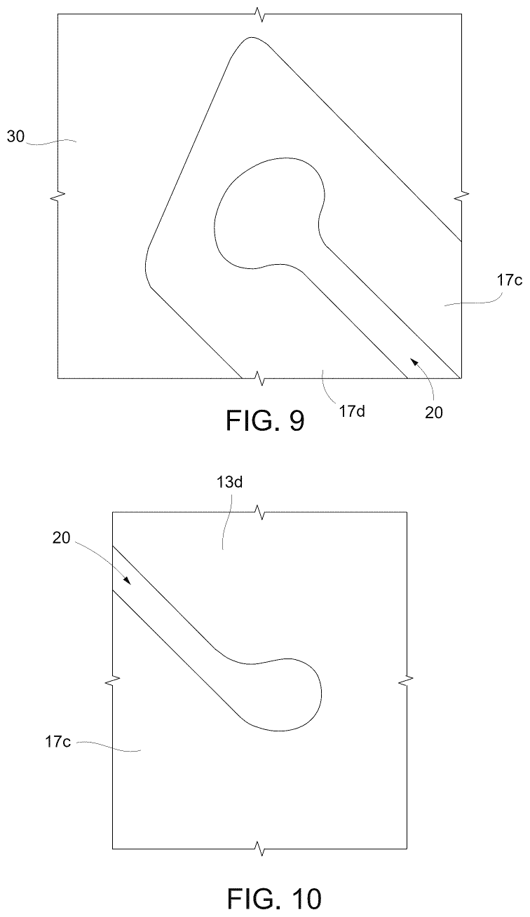

Along the axis A, the elastic elements 17 are divided by a separation slit 19 that extends in a radial direction from the tab 13b to the supporting frame 12. Transverse slits 20 (see also FIGS. 9 and 10), perpendicular to the axis A, delimit the outer arms 17c and the inner arms 17d and separate them from the respective side of the supporting frame 12 and from the tab 13b of the respective sector 13a of the membrane 13. As shown in the enlargements of FIGS. 9 and 10, the ends of the transverse slits 20 are widened and rounded to avoid the concentration of force lines and prevent the initiation of cracks.

In a direction perpendicular to the transverse slits 20, the outer arms 17c and the inner arms 17d have a width W1 of between 30 μm and 70 μm, for example 50 μm, and a length of, for example, between 500 μm and 1.5 mm. The outer anchor 17a and the inner anchor 17b have a width W2 of between 70 μm and 150 μm, for example 100 μm.

The piezoelectric actuator 15 (FIG. 2) is arranged on the central portion 13c of the membrane 13 and, in one embodiment, comprises lobes 15a that extend in a radial direction from an annular actuator region 15b, each on the tab 13b of a respective sector 13a of the membrane 13. The piezoelectric actuator 15 has the same N-fold rotational symmetry as the membrane 13.

The piezoelectric actuator 15 and the membrane 13 form a composite membrane wherein the residual stress state of the materials is exploited to obtain a deformation of the membrane at rest, i.e., in the absence of electrical stimuli to the piezoelectric actuator 15. As described in Seung-Mock Lee, Tsunehisa Tanaka, Koji Inoue “Residual Stress and Membrane Deflection Influences on the Ultrasonic Sensor Device”, IEEE Sensors 2006, EXCO, Daegu, Korea, Oct. 22-25, 2006 (incorporated herein by reference), in composite membranes, differences in materials and process factors induce residual stresses that tend to cause mechanical strains. For example, a composite membrane may comprise a semiconductor membrane and a stack of layers forming a piezoelectric actuator, as in the case of the electroacoustic transducer 10. The semiconductor membrane is typically subject to residual compressive stresses, while the residual stress state of the piezoelectric actuator (in particular defined by a Pt/PZT/Pt stack) may be controlled so as to be either of the tensile or compressive type and determines the deflection of the composite membrane. If the residual stress state of the piezoelectric actuator is of the compressive type, the composite membrane deflects towards the side of the piezoelectric actuator, in a direction opposite to the cavity underlying the membrane; if the residual stress state of the piezoelectric actuator is of the tensile type, the composite membrane has a deflection towards the side of the semiconductor membrane, in the direction of the cavity underlying the membrane.

In the embodiment described here, in particular, the residual stress state is of the compressive type and causes a deflection of the membrane 13 with respect to a planar configuration towards the side 13d of the piezoelectric actuator 15, so that the membrane 13 has the shape of a dome open towards the cavity 16 (as shown in FIGS. 5a and 5b) in rest conditions, i.e., in the absence of electrical stimuli to the piezoelectric actuator 15 (deflection at rest). Furthermore, the piezoelectric actuator 15 is configured to deform the membrane 13 in response to an electrical driving signal VD, for example applied by the driving stage 11, so as to cause an induced deflection of the membrane 13 opposite to the deflection at rest (due to the residual stress of the material), i.e., towards the side 13e of the membrane 13 opposite to the piezoelectric actuator 15 and facing the cavity 16 (FIGS. 6a and 6b). In practice, in response to the driving signal VD, the membrane 13 assumes the shape of a cup open in the direction opposite to the cavity 16.

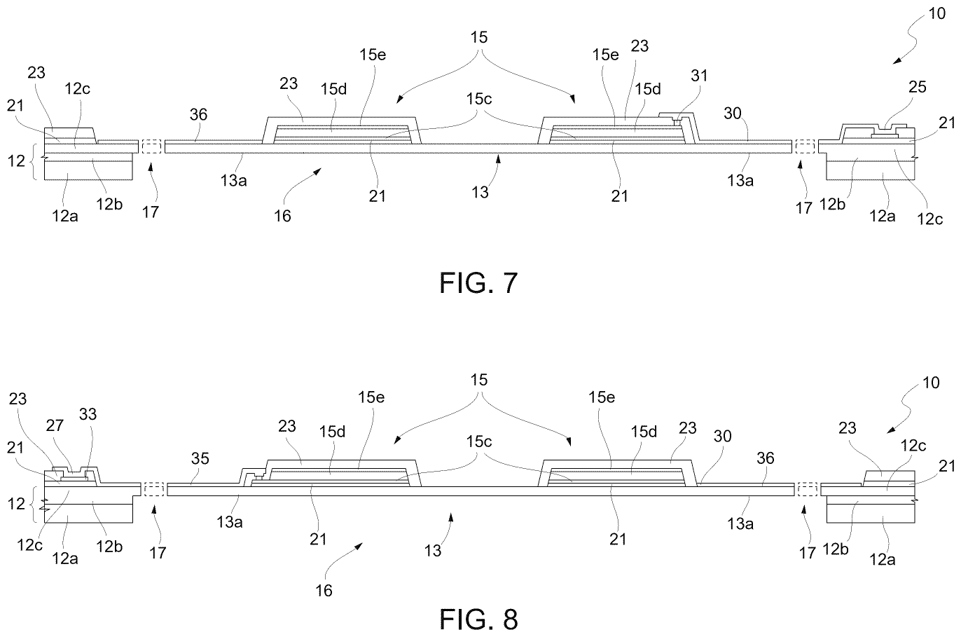

To provide the electrical driving signal VD, the electroacoustic transducer 10 comprises electrical connections that run partly on the membrane 13, including at least some of the elastic elements 17. The structure of the piezoelectric actuator 15 and the electrical connections, as well as the supporting frame 12 and the membrane 13, is shown in detail in the sections of FIGS. 7 and 8, where, for simplicity, the membrane 13 is illustrated in a planar configuration that does not correspond to the rest configuration, in the absence of electrical stimuli to the piezoelectric actuator 15. A dielectric layer 21, for example silicon oxide, is formed on the outermost of the structural layers 12c and covers the supporting frame 12 and portions of the membrane 13 corresponding to the piezoelectric actuator 15. The piezoelectric actuator 15 is formed from a piezoelectric stack comprising a bottom metallization structure, for example containing a layer of platinum; a layer of piezoelectric material, for example PZT, on the bottom metallization structure; and an upper metallization structure, for example also containing a layer of platinum, on the layer of piezoelectric material. In particular, the piezoelectric actuator 15 comprises a bottom electrode 15c, formed from the bottom metallization structure and arranged on the dielectric layer 21; a piezoelectric body 15d, formed from the piezoelectric layer and arranged on the bottom electrode 15c; and an upper electrode 15e, formed from the upper metallization structure and arranged on the piezoelectric body 15d. A passivation structure 23, for example comprising a layer of silicon nitride and possibly covered by one or more electrically insulating layers, protects the supporting frame 12 and the piezoelectric actuator 15. Outside the piezoelectric actuator 15, the surface of the membrane 13 opposite to the cavity 16 is substantially free.

Pads 25, 27 on the supporting frame 12 (FIG. 2) are accessible for biasing, respectively, the upper electrode 15e and the bottom electrode 15c by metal lines running on the side 13d of the membrane 13, inducing a deformation of the membrane in the direction opposite to the cavity 16.

The pad 25 is coupled to the upper electrode 15e through a first exposed metal line 30, made of a conductive material that is immune to oxidation by exposure to the atmosphere and does not require passivation, for example gold or platinum. The first exposed metal line 30 (FIG. 7) extends along an arbitrary path on the passivation structure 23 above the supporting frame 12 from the pad 25 to the periphery of the membrane 13, then on the elastic elements 17 of a respective one of the sectors 13a of the membrane 13 and from there in a radial direction along the bisector of the same sector 13a up to the corresponding lobe 15a of the piezoelectric actuator 15. A radially inner end of the first exposed metal line 30 overlaps an edge of the lobe 15a and is electrically coupled thereto by an interconnect 31, for example of copper, aluminum or an alloy thereof, through the passivation structure 23. In particular, the first exposed metal line 30 extends symmetrically on the outer arms 17c and on the inner arms 17d of both the elastic elements 17 of the respective sector of the membrane 13. In one embodiment, the first exposed metal line 30 is formed directly on the membrane 13, where free of the piezoelectric actuator 15, and on the elastic elements 17. The first exposed metal line 30 has a width W3 smaller than the width W1 of the outer arms 17c and the inner arms 17d, in one embodiment not greater than half the width W1 and for example equal to 20 μm.

The pad 27 (FIG. 8) is coupled to the bottom electrode 15c through a metal line 33, which extends on the dielectric layer 21 and is incorporated into the passivation structure 23, and through a second exposed metal line 35 that extends along an arbitrary path on the passivation structure 23 above the supporting frame 12 from the pad 27 to the periphery of the membrane 13, then on the elastic elements 17 of a respective one of the sectors 13a of the membrane 13, different from the sector 13a accommodating the first exposed metal line 30, and from there in a radial direction along the bisector of the same sector 13a up to the corresponding lobe 15a of the piezoelectric actuator 15. In a non-limiting embodiment, the sector 13a accommodating the second exposed metal line 35 is rotated by 90° with respect to the sector 13a accommodating the first exposed metal line 30. The second exposed metal line 35 has ends overlapping an extension of the bottom electrode 15c and electrically coupled thereto by interconnects 34 through the passivation structure 23. The second exposed metal line 35 is made of the same material as the first exposed metal line 30 and has the same shape, except for a rotation by 90°.

In one embodiment, dummy metal lines 36 are formed on sectors 13a of the membrane 13 opposite with respect to those accommodating the first exposed metal line 30 and the second exposed metal line 35. The dummy metal lines 36 extend on the elastic elements 17 and along the bisectors of the respective sectors 13a of the membrane 13 up to the proximity of the respective lobes 15a of the piezoelectric actuator, are made of the same material and have the same shape as the first exposed metal line 30 and the second exposed metal line 35. The dummy metal lines 36 are decoupled from the piezoelectric actuator 15, are floating and have the sole function of mechanically balancing the stresses applied to the membrane 13 by the first exposed metal line 30 and the second exposed metal line 35.

It is understood that the arrangement and the geometric shape of the first exposed metal line 30, the second exposed metal line 35 and any dummy metal lines 36 may however be different from what has been described above.

In one embodiment not shown, for example, the second exposed metal line is opposite to the first exposed metal line and dummy metal lines are not present.

In another embodiment not shown, dummy metal lines are present in all sectors 13a (FIG. 3) of the membrane 13 not occupied by the first exposed metal line and the second exposed metal line.

In the example described above, the metal lines that connect the piezoelectric actuator to the pads 25, 27, as well as the dummy metal lines 36 if any, are exposed and free of any passivating coating and, in general, of any coating. This is possible because such metal lines are made of a metal immune to oxidation by exposure to the atmosphere, and the absence of coating is particularly advantageous because the effects on the deformability of the membrane 13 and the elastic elements 17 are minimal and, in fact, completely negligible. However, a passivating coating and/or another coating might still be present in accordance with design preferences, for example if the deformability of the membrane and the elastic elements is still considered satisfactory. In this case, the metal lines would not be directly exposed to the atmosphere.

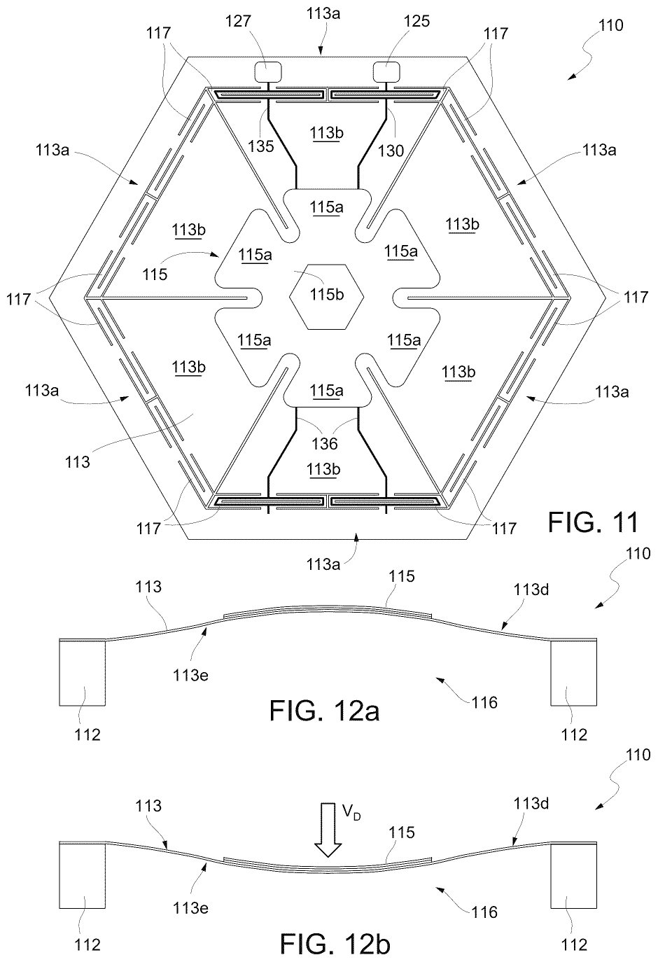

With reference to FIG. 11, an electroacoustic transducer 110 comprises a supporting frame 112, a membrane 113 and a piezoelectric transducer, in particular a piezoelectric actuator 115. The membrane 113, for example of polycrystalline silicon, has the shape of a regular polygon with N-fold rotational symmetry, for example an hexagon, and is connected to the supporting frame 112 along its perimeter by elastic elements 117. The membrane 113 is divided into a plurality of sectors 113a, delimited by radial slits 118 that extend in a radial direction from respective vertices of the membrane 113 towards the inside, up to a distance from the center of the membrane 113. In each sector 113a of the membrane 113, the radial slits 118 delimit tabs 113b coupled to the supporting frame 112 by respective elastic elements 117. More precisely, each tab 113b is coupled to the supporting frame 112 by a plurality of respective elastic elements 117, here two, arranged symmetrically to each other with respect to a bisector of the respective sector 113a. Each elastic element 117 comprises an outer anchor 117a, fixed to the supporting frame 112, an inner anchor 117b fixed to the tab 113b, outer arms 117c and inner arms 117d. The use of multiple elastic elements 117 in each sector 113a allows suitable mobility of the membrane 113 to be ensured, preventing the elastic elements 117 from being weakened due to the dimensions at the periphery of the tabs 113a.

The piezoelectric actuator 115 is arranged on a central portion of the membrane 113 and comprises lobes 115a that extend in a radial direction from an annular actuator region 115b, each on the tab 113b of a respective sector 113a of the membrane 113. The piezoelectric actuator 115 has the structure of the piezoelectric actuator 15 already described, with a bottom electrode, a piezoelectric body and an upper electrode and is not illustrated in detail. Furthermore, also in this case, the residual stress state of the piezoelectric actuator 115 causes a deflection of the membrane 113 towards the side 113d of the piezoelectric actuator 115, so that the membrane 113 has the shape of a dome open towards the cavity 116 (as shown in FIG. 12a) in rest conditions, i.e., in the absence of electrical stimuli to the piezoelectric actuator 115. Furthermore, the piezoelectric actuator 115 is configured to deform the membrane 113 in response to an electrical driving signal VD, for example applied by the driving stage 11, so as to cause a deflection of the membrane 113 opposite to the deflection at rest, towards the side 113e of the membrane 113 opposite to the piezoelectric actuator 115 and facing the cavity 116 (FIG. 12b).

Pads 125, 127 on the supporting frame 112 are accessible for biasing the upper electrode and the bottom electrode of the piezoelectric actuator 115 (not shown in detail here). The pads 125, 127 are coupled to the piezoelectric actuator 115 through a first exposed metal line 130 and a second exposed metal line 135, respectively, both made of a conductive material that is immune to oxidation by exposure to the atmosphere and does not require passivation, for example gold or platinum. The first exposed metal line 130 extends along an arbitrary path from the pad 125 to the periphery of the membrane 113, on a first of the elastic elements 117 of one of the sectors 113a and from there on the tab 113b of the same sector 113a. The first exposed metal line 130 has a radially inner end coupled to the upper electrode of the piezoelectric actuator 115 at one edge of the corresponding lobe 115a. The second exposed metal line 135 extends along an arbitrary path from the pad 127 to the periphery of the membrane 113, on a second of the elastic elements 117 of the same sector 113a of the membrane 113 as that accommodating the first exposed metal line 130 and from there on the tab 113b of the same sector 113a. The second exposed metal line 135 has a radially inner end coupled to the bottom electrode of the piezoelectric actuator 115 at one edge of the lobe 115a.

Dummy metal lines 136 are formed on sectors 113a of the membrane 113 different from those accommodating the first exposed metal line 130 and the second exposed metal line 135. The dummy metal lines 136 extend on respective elastic elements 117 and on the tab 113b of the sector 113a of the membrane 113 not accommodating the first exposed metal line 130 and the second exposed metal line 135, up to the proximity of the corresponding lobe 115a of the piezoelectric actuator 115, are made of the same material and have the same shape as the first exposed metal line 130 and the second exposed metal line 135. The dummy metal lines 136 are decoupled from the piezoelectric actuator 115, are floating and have the sole function of mechanically balancing the stresses applied to the membrane 113 by the first exposed metal line 130 and the second exposed metal line 135.

As described above, the piezoelectric transducer is capable of producing a deflection at rest and an induced deflection respectively in the absence of electrical stimuli and in response to a driving signal. In other words, the electroacoustic transducer according to the invention allows wide dynamics of the membrane to be exploited using a single piezoelectric actuator. There is therefore a double advantage: on the one hand, the sound pressure level that may be obtained is satisfactory and comparable to that of electroacoustic transducers provided with distinct piezoelectric actuators to move the membrane in opposite directions. On the other hand, the use of a single piezoelectric actuator with a reduced surface area significantly decreases the associated capacitance and, consequently, power consumption. In turn, the reduction in power consumption may translate into greater autonomy, which is highly appreciated by users of mobile devices because it simplifies their use.

Furthermore, the metal lines allow biasing of the piezoelectric actuator, which is placed on the membrane connected to the supporting frame by elastic elements, without appreciably modifying the elastic behavior of the membrane. More precisely, the use of metals immune to oxidation by exposure to air allows the formation of exposed metal lines that do not require passivation structures or, if desired in accordance with design preferences, allows providing the metal lines with very thin passivating coatings at least on the membrane and on the elastic elements. In other words, the addition of material on the membrane may be strictly limited to the metal of the lines themselves, avoiding superfluous structures that would stiffen the membrane and might reduce the dynamics. Alternatively, when the deformability of the membrane is still considered satisfactory in accordance with design preferences, the metal lines may be provided with thin coatings, in particular passivating coatings, which do not substantially alter the performance of the membrane and the elastic elements.

Furthermore, very high conductivity materials may be used and the dimensions of the metal lines may be correspondingly reduced. In general, this avoids stiffening the membrane, to the advantage of the sound pressure level (for transmitters or actuators) and the sensitivity (for receivers or sensors). Furthermore, the metal lines may be narrow enough to run on the elastic elements, without significantly altering their mechanical properties and without the need for dedicated membrane portions.

Finally, it is clear that modifications and variations may be made to the electroacoustic transducer described, without departing from the scope of the present invention, as defined in the appended claims.

It is understood, in particular, that electroacoustic transducers according to the invention may be effectively used in devices other than micro-speakers, such as, but not limited to, microphones and probes for ultrasound inspection and imaging. While maintaining the same general structure, the electroacoustic transducers may operate either as transmitters (for example micro-speakers) or as receivers (for example microphones) and, in some applications, in a reversible manner both as transmitters and as receivers (for example, in ultrasound imaging probes-PMUT). This is possible because the piezoelectric transducers present on the membrane may operate as actuators in transmitters, converting electrical signals into deformations of the membrane to generate acoustic waves, and as sensors in receivers, converting deformations of the membrane caused by impinging acoustic waves into electrical signals.

1. A microelectromechanical electroacoustic transducer, comprising:
a supporting frame, containing semiconductor material;
a membrane of semiconductor material connected to the supporting frame along a perimeter a piezoelectric transducer on a central portion of the membrane;
wherein the piezoelectric transducer is configured to cause a deflection at rest of the membrane from a planar configuration towards a first side of the membrane, in an absence of electrical stimuli to the piezoelectric transducer, and to cause an induced deflection of the membrane opposite to the deflection at rest towards a second side of the membrane in response to an electrical driving signal.

2. The microelectromechanical electroacoustic transducer according to claim 1, wherein the piezoelectric transducer and the membrane form a composite membrane and have respective residual stress states of a compression type.

3. The microelectromechanical electroacoustic transducer according to claim 1, wherein the piezoelectric transducer is on the first side of the membrane.

4. The microelectromechanical electroacoustic transducer according to claim 1, wherein the membrane is divided into sectors by radial slits extending from a periphery of the membrane up to a distance from a center of the membrane.

5. The microelectromechanical electroacoustic transducer according to claim 4, wherein the piezoelectric transducer comprises an annular actuator region and lobes extending in a radial direction from the annular actuator region, each on a respective sector of the membrane.

6. The microelectromechanical electroacoustic transducer according to claim 1, wherein the piezoelectric transducer and the membrane form a composite membrane and have respective residual stress states of a compression type.

7. The microelectromechanical electroacoustic transducer according to claim 1, wherein the piezoelectric transducer is on the first side of the membrane.

8. The microelectromechanical electroacoustic transducer according to claim 1, comprising elastic elements, defined by respective portions of the membrane, the membrane being connected to the supporting frame by the elastic elements; and
metal lines extending on respective elastic elements on the membrane from the respective elastic elements to the piezoelectric transducer.

9. The microelectromechanical electroacoustic transducer according to claim 8, wherein the metal lines are of a metal immune to oxidation by exposure to atmosphere, for example gold or platinum.

10. The microelectromechanical electroacoustic transducer according to claim 8, wherein the metal lines are free of coating and are exposed on the membrane and on the elastic elements.

11. The microelectromechanical electroacoustic transducer according to claim 8, wherein the piezoelectric transducer comprises a bottom electrode, a piezoelectric body on the bottom electrode and a top electrode on the piezoelectric body and wherein the metal lines comprise a first metal line connecting the top electrode to a first pad on the supporting frame and a second metal line connecting the bottom electrode to a second pad on the supporting frame.

12. The microelectromechanical electroacoustic transducer according to claim 11, wherein each sector comprises a pair of respective elastic elements, arranged symmetrically to each other with respect to an axis extending along a bisector of the respective sector; and wherein each elastic element comprises an outer anchor, fixed to the supporting frame, an inner anchor, connected to the central portion of the membrane, outer arms extending in opposite directions from the outer anchor and inner arms extending in opposite directions from the inner anchor.

13. The microelectromechanical electroacoustic transducer according to claim 12, wherein in each elastic element the outer arms and the inner arms are parallel to each other and are connected to each other, to the outer anchor and to the inner anchor so as to form a slot.

14. The microelectromechanical electroacoustic transducer according to claim 12, wherein the first metal line and the second metal line extend on respective distinct sectors of the membrane and each on both elastic elements of the respective sector.

15. The microelectromechanical electroacoustic transducer according to claim 12, wherein the first metal line and the second metal line extend on a same one of the sectors of the membrane and each on a respective one of the elastic elements of the sector.

16. The microelectromechanical electroacoustic transducer according to claim 11, wherein the metal lines comprise dummy metal lines in each sector of the membrane opposite to one of the sectors accommodating the first metal line and/or the second metal line, wherein the metal lines extend at least on the elastic element of the respective sector of the membrane and up to the piezoelectric transducer and wherein the metal lines are electrically insulated from the piezoelectric transducer.

17. The microelectromechanical electroacoustic transducer according to claim 1, wherein the membrane has N-fold rotational symmetry, N being an integer.

18. A method, comprising:
forming a supporting frame of semiconductor material;
opening a cavity on one side of the supporting frame;
connecting a membrane of semiconductor material to the supporting frame along a perimeter of the membrane by elastic elements, the membrane closing the cavity;
dividing the membrane into a plurality of sectors by forming radial slits extending from respective vertices of the membrane toward a center of the membrane, the radial slits defining tabs in the membrane that are coupled to the supporting frame by the elastic elements and connected to each other by a continuous central portion of the membrane;
arranging a piezoelectric actuator on the central portion of the membrane, the piezoelectric actuator comprising a bottom electrode, a piezoelectric body, and an upper electrode;
forming the radial slits with a width that is less than twice a thickness of a viscous boundary layer of air in an operating temperature range;
forming exposed metal lines that extend on the elastic elements, the exposed metal lines being made of a conductive material that is immune to oxidation by exposure to atmosphere;
wherein the piezoelectric actuator and the membrane form a composite membrane having a residual stress state that causes a deflection of the membrane at rest in a first direction toward a side of the piezoelectric actuator; and
applying an electrical driving signal through the exposed metal lines to the piezoelectric actuator to cause an induced deflection of the membrane in a second direction opposite to the first direction, toward a side of the membrane opposite to the piezoelectric actuator and facing the cavity.

19. The method of claim 18, wherein the membrane has an N-fold rotational symmetry with respect to an axis perpendicular to the membrane and passing through the center, with N being an integer, and wherein the piezoelectric actuator has a same N-fold rotational symmetry as the membrane.

20. The method of claim 18, wherein the membrane has a shape of a regular polygon, and wherein N is an even number.

21. The method of claim 18, wherein each tab is coupled to the supporting frame by a pair of elastic elements arranged symmetrically to each other with respect to an axis that extends along a bisector of the respective sector.

22. The method of claim 18, wherein the piezoelectric actuator comprises lobes that extend in a radial direction from an annular actuator region, each lobe being arranged on the tab of a respective sector of the membrane, and wherein applying the electrical driving signal comprises biasing the upper electrode and the bottom electrode through the exposed metal lines extending along bisectors of respective sectors of the membrane.

23. The method of claim 22, further comprising:
forming dummy metal lines on sectors of the membrane different from those accommodating the exposed metal lines, the dummy metal lines being made of a same material and having a same shape as the exposed metal lines but being electrically decoupled from the piezoelectric actuator, wherein the dummy metal lines mechanically balance stresses applied to the membrane by the exposed metal lines.
